(19) United States
(12) Patent Application Publication
(10) Pub. No.: US 2026/0313755 A1
(43) Pub. Date: Oct. 8, 2026

(54) METHOD FOR MANUFACTURING EMBEDDED TRACE SUBSTRATE

(71) Applicant: NISSHA CO., LTD., Kyoto-shi, Kyoto (JP)

(72) Inventors: Toshifumi KUROSAKI, Otsu-shi, Shiga (JP); Takashi YOKOYAMA, Otsu-shi, Shiga (JP)

(21) Appl. No.: 19/478,772

(22) PCT Filed: Mar. 7, 2024
(86) PCT No.: PCT/JP2024/008747

§ 371 Date: Oct. 24, 2025

(30) Foreign Application Priority Data
Apr. 27, 2023 (JP) 2023-073829

(51) Int. Cl. H05B 3/00; H05B 3/20; H05B 3/34

(52) U.S. Cl. CPC H05B 3/0019; H05B 3/20; H05B 3/34; H05B 2203/013

(57) ABSTRACT

A method is provided that includes preparing a film, arranging two electrode pads at the film along a first direction, forming a circuit including a conductive wire by embedding the circuit in the film using an ultrasonic welding machine, with the circuit having a functional portion having an arbitrary pattern, two wiring portions led out from both ends of the functional portion, and two end portions extending in the first direction from the wiring portions so as to partly overlap the electrode pads, and connecting the electrode pads and the conductive wire. One ends of the two end portions are located on the same side with respect to the two electrode pads in plan view. The two end portions have a length for absorbing a positional deviation of the electrode pads in the first direction relative to the circuit.

### CROSS-REFERENCE TO RELATED APPLICATIONS

This application is a U.S. National stage of International Application No. PCT/JP 2024/008747 filed on Mar. 7, 2024. This application claims priority to Japanese Patent Application No. 2023-073829 filed on Apr. 27, 2023 with Japan Patent Office.

### BACKGROUND

### Field of the Invention

The present invention relates to a method for manufacturing an embedded trace substrate.

### Background Information

A film heater in which one thin metal wire is embedded in a film in an arbitrary pattern is known (see, for example, JP 2022-066706 A (Patent Literature 1)).

Referring to FIGS. 12A and 12B, such a film heater 100 includes a film 200, a first electrode pad 500 and a second electrode pad 600 that have a quadrangular shape and that are arranged along a Y direction at a peripheral edge of the film 200 in parallel to each other with a space therebetween, and a circuit 400 including one thin metal wire 300 embedded in the film 200.

The circuit 400 includes a heater portion 450 having an arbitrary pattern, a first wiring portion 430 and a second wiring portion 440 respectively led out from both ends of the heater portion 450, and a first end portion 410 and a second end portion 420 respectively extending from the first wiring portion 430 and the second wiring portion 440 in a direction (+X direction in FIGS. 12A and 12B) away from the heater portion 450 and overlapping the first electrode pad 500 and the second electrode pad 600, respectively. The circuit 400 is embedded by melting a contact surface of the film 200 with the thin metal wire 300 by applying ultrasonic vibration using an ultrasonic welding machine. For example, the first wiring portion 430, the heater portion 450, the second wiring portion 440, and the second end portion 420 can be embedded in this order from the first end portion 410.

The first end portion 410 and the second end portion 420 respectively straddle the first electrode pad 500 and the second electrode pad 600 in the X direction. Upper surfaces of the first electrode pad 500 and the second electrode pad 600 are electrically connected to the thin metal wire 300 that constitutes the first end portion 410 and the second end portion 420 and that is in contact with the upper surfaces. When a voltage is applied to the first electrode pad 500 and the second electrode pad 600, a current is generated in the circuit 400, and the heater portion 450 generates heat.

### SUMMARY

In a conventional method for manufacturing the film heater 100, first, the electrode pads 500 and 600 are disposed on the film 200, and a corner of the film 200 is set in contact with a jig (not illustrated). Thereafter, the thin metal wire 300 is embedded in the film 200 such that the first end portion 410 and the second end portion 420 overlap the electrode pads 500 and 600. The arrangement of the electrode pads 500 and 600 and the embedding of the thin metal wire 300 are separate processes, resulting in that the following positional deviation occurs. That is, (1) positional deviation of the electrode pads, (2) positional deviation of the embedded position of the thin metal wire, and (3) positional deviation of the electrode pads and the embedded position of the thin metal wire. In this manufacturing method, when the arrangement positions of the electrode pads 500 and 600 are shifted in, for example, the +Y direction in FIG. 12A, the embedded position of the thin metal wire 300 is relatively shifted in the −Y direction in FIG. 12A. That is, in the conventional manufacturing method, it is difficult to align the electrode pads 500 and 600 and the circuit 400, and thus there is a problem that the non-defective rate is hardly increased.

One object of the present disclosure is to provide a method for manufacturing an embedded trace substrate with which it is possible to improve a non-defective rate by increasing the alignment accuracy between a circuit and an electrode pad.

According to a first aspect of the present disclosure for achieving the above-mentioned object, a method for manufacturing an embedded trace substrate includes:
a preparation step of preparing a film;
an arrangement step of arranging a first electrode pad and a second electrode pad at a peripheral edge of a first main surface of the film along a first direction so as to be parallel to each other and spaced from each other;
a circuit formation step of forming, on the first main surface of the film, a circuit including a conductive wire obtained by coating a thin metal wire with an insulating coating, the circuit having a functional portion having an arbitrary pattern, a first wiring portion led out from one end of both ends of the functional portion to an outside of the functional portion, a second wiring portion led out from another end of both ends of the functional portion to the outside of the functional portion, a first end portion extending in the first direction from the first wiring portion so as to partly overlap the first electrode pad and the second electrode pad, and a second end portion extending along the first end portion from the second wiring portion so as to partly overlap the first electrode pad and the second electrode pad, the circuit being formed by embedding the functional portion, the first wiring portion, the second wiring portion, and sections of the first end portion and the second end portion not overlapping the first electrode pad and the second electrode pad in the first main surface of the film using an ultrasonic welding machine;
a first connection step of removing the insulating coating of the conductive wire located on the first electrode pad and electrically connecting the thin metal wire that is exposed to the first electrode pad; and
a second connection step of removing the insulating coating of the conductive wire located on the second electrode pad and electrically connecting the thin metal wire that is exposed to the second electrode pad, wherein
one end connected to the first wiring portion out of both ends of the first end portion and one end connected to the second wiring portion out of both ends of the second end portion are located on a same side with respect to the first electrode pad and the second electrode pad in plan view,
the ultrasonic welding machine includes a horn that melts a contact surface of the film with the conductive wire by applying ultrasonic vibration and that embeds the conductive wire into the first main surface of the film, and the conductive wire to be continuously drawn out from a tip of the horn onto the first main surface of the film through an inside of the horn, and
the first end portion and the second end portion have a length for absorbing a positional deviation of the first electrode pad and the second electrode pad in the first direction relative to the circuit.

According to a second aspect of the present disclosure for achieving the above-mentioned object, a method for manufacturing an embedded trace substrate includes:
a preparation step of preparing a film;
an arrangement step of arranging a first electrode pad and a second electrode pad at a peripheral edge of a first main surface of the film along a first direction so as to be parallel to each other and spaced from each other;
a circuit formation step of forming, on the first main surface of the film, a circuit including a conductive wire obtained by coating a thin metal wire with an insulating coating, the circuit having a functional portion having an arbitrary pattern, a first wiring portion led out from one end of both ends of the functional portion to an outside of the functional portion, a second wiring portion led out from another end of both ends of the functional portion to the outside of the functional portion, a first end portion extending in the first direction from the first wiring portion so as to partly overlap the first electrode pad and the second electrode pad, and a second end portion extending along the first end portion from the second wiring portion so as to partly overlap the first electrode pad and the second electrode pad, the circuit being formed by embedding the functional portion, the first wiring portion, the second wiring portion, and sections of the first end portion and the second end portion not overlapping the first electrode pad and the second electrode pad in the first main surface of the film using an ultrasonic welding machine;
a first connection step of removing the insulating coating of the conductive wire located on the first electrode pad and electrically connecting the thin metal wire that is exposed to the first electrode pad; and
a second connection step of removing the insulating coating of the conductive wire located on the second electrode pad and electrically connecting the thin metal wire that is exposed to the second electrode pad, wherein
one end connected to the first wiring portion out of both ends of the first end portion and one end connected to the second wiring portion out of both ends of the second end portion are located at positions sandwiching the first electrode pad and the second electrode pad in plan view,
the ultrasonic welding machine includes a horn that melts a contact surface of the film with the conductive wire by applying ultrasonic vibration and that embeds the conductive wire into the first main surface of the film, and the conductive wire to be continuously drawn out from a tip of the horn onto the first main surface of the film through an inside of the horn, and
the first end portion and the second end portion have a length for absorbing a positional deviation of the first electrode pad and the second electrode pad in the first direction relative to the circuit.

According to the manufacturing methods provided by the first and second aspects, even when the first electrode pad and the second electrode pad are shifted in the first direction relative to the embedded positions of the first end portion and the second end portion, the first end portion and the second end portion have sections overlapping the two electrode pads, respectively, because the first end portion and the second end portion have a length for absorbing a positional deviation of the first electrode pad and the second electrode pad in the first direction relative to the circuit. Therefore, the accuracy in alignment between the circuit and the two electrode pads is increased, whereby the non-defective rate can be improved.

According to a third aspect of the present disclosure for achieving the above-mentioned object, a method for manufacturing an embedded trace substrate includes:
a preparation step of preparing a film;
an arrangement step of arranging a first electrode pad, a second electrode pad, a third electrode pad, and a fourth electrode pad at a peripheral edge of a first main surface of the film along a first direction so as to be parallel to each other and spaced from each other;
a first circuit formation step of forming, on the first main surface of the film, a first circuit including a first conductive wire obtained by coating a thin metal wire with an insulating coating, the first circuit having a first functional portion having an arbitrary pattern, a first wiring portion led out from one end of both ends of the first functional portion to an outside of the first functional portion, a second wiring portion led out from another end of both ends of the first functional portion to the outside of the first functional portion, a first end portion extending in the first direction from the first wiring portion so as to partly overlap the first electrode pad, the second electrode pad, the third electrode pad, and the fourth electrode pad, and a second end portion extending along the first end portion from the second wiring portion so as to partly overlap the first electrode pad, the second electrode pad, the third electrode pad, and the fourth electrode pad, the first circuit being formed by embedding the first functional portion, the first wiring portion, the second wiring portion, and sections of the first end portion and the second end portion not overlapping the first electrode pad, the second electrode pad, the third electrode pad, and the fourth electrode pad in the first main surface of the film using an ultrasonic welding machine;
a second circuit formation step of forming, on the first main surface of the film, a second circuit including a second conductive wire obtained by coating a thin metal wire with an insulating coating, the second circuit having a second functional portion having an arbitrary pattern, a third wiring portion led out from one end of both ends of the second functional portion to an outside of the second functional portion, a fourth wiring portion led out from another end of both ends of the second functional portion to the outside of the second functional portion, a third end portion extending in the first direction from the third wiring portion so as to partly overlap the first electrode pad, the second electrode pad, the third electrode pad, and the fourth electrode pad, and a fourth end portion extending along the third end portion from the fourth wiring portion so as to partly overlap the first electrode pad, the second electrode pad, the third electrode pad, and the fourth electrode pad, the second circuit being formed by embedding the second functional portion, the third wiring portion, the fourth wiring portion, and sections of the third end portion and the fourth end portion not overlapping the first electrode pad, the second electrode pad, the third electrode pad, and the fourth electrode pad in the first main surface of the film using an ultrasonic welding machine;
a first connection step of removing the insulating coating of the first conductive wire located on the first electrode pad and electrically connecting the thin metal wire that is exposed to the first electrode pad;
a second connection step of removing the insulating coating of the first conductive wire located on the second electrode pad and electrically connecting the thin metal wire that is exposed to the second electrode pad,
a third connection step of removing the insulating coating of the second conductive wire located on the third electrode pad and electrically connecting the thin metal wire that is exposed to the third electrode pad; and
a fourth connection step of removing the insulating coating of the second conductive wire located on the fourth electrode pad and electrically connecting the thin metal wire that is exposed to the fourth electrode pad, wherein
one end connected to the first wiring portion out of both ends of the first end portion, one end connected to the second wiring portion out of both ends of the second end portion, one end connected to the third wiring portion out of both ends of the third end portion, and one end connected to the fourth wiring portion out of both ends of the fourth end portion are located on a same side with respect to the first electrode pad, the second electrode pad, the third electrode pad, and the fourth electrode pad in plan view,
in the first circuit formation step, the ultrasonic welding machine includes a horn that melts a contact surface of the film with the first conductive wire by applying ultrasonic vibration and that embeds the first conductive wire into the first main surface of the film, and the first conductive wire to be continuously drawn out from a tip of the horn onto the first main surface of the film through an inside of the horn,
in the second circuit formation step, the ultrasonic welding machine includes the horn that melts a contact surface of the film with the second conductive wire by applying ultrasonic vibration and that embeds the second conductive wire into the first main surface of the film, and the second conductive wire to be continuously drawn out from the tip of the horn onto the first main surface of the film through the inside of the horn, and
the first end portion, the second end portion, the third end portion, and the fourth end portion have a length for absorbing a positional deviation of the first electrode pad, the second electrode pad, the third electrode pad, and the fourth electrode pad in the first direction relative to the first circuit and the second circuit.

According to a fourth aspect of the present disclosure for achieving the above-mentioned object, a method for manufacturing an embedded trace substrate includes:
a preparation step of preparing a film;
an arrangement step of arranging a first electrode pad, a second electrode pad, a third electrode pad, and a fourth electrode pad at a peripheral edge of a first main surface of the film along a first direction so as to be parallel to each other and spaced from each other;
a first circuit formation step of forming, on the first main surface of the film, a first circuit including a first conductive wire obtained by coating a thin metal wire with an insulating coating, the first circuit having a first functional portion having an arbitrary pattern, a first wiring portion led out from one end of both ends of the first functional portion to an outside of the first functional portion, a second wiring portion led out from another end of both ends of the first functional portion to the outside of the first functional portion, a first end portion extending in the first direction from the first wiring portion so as to partly overlap the first electrode pad, the second electrode pad, the third electrode pad, and the fourth electrode pad, and a second end portion extending along the first end portion from the second wiring portion so as to partly overlap the first electrode pad, the second electrode pad, the third electrode pad, and the fourth electrode pad, the first circuit being formed by embedding the first functional portion, the first wiring portion, the second wiring portion, and sections of the first end portion and the second end portion not overlapping the first electrode pad, the second electrode pad, the third electrode pad, and the fourth electrode pad in the first main surface of the film using an ultrasonic welding machine;
a second circuit formation step of forming, on the first main surface of the film, a second circuit including a second conductive wire obtained by coating a thin metal wire with an insulating coating, the second circuit having a second functional portion having an arbitrary pattern, a third wiring portion led out from one end of both ends of the second functional portion to an outside of the second functional portion, a fourth wiring portion led out from another end of both ends of the second functional portion to the outside of the second functional portion, a third end portion extending in the first direction from the third wiring portion so as to partly overlap the first electrode pad, the second electrode pad, the third electrode pad, and the fourth electrode pad, and a fourth end portion extending along the third end portion from the fourth wiring portion so as to partly overlap the first electrode pad, the second electrode pad, the third electrode pad, and the fourth electrode pad, the second circuit being formed by embedding the second functional portion, the third wiring portion, the fourth wiring portion, and sections of the third end portion and the fourth end portion not overlapping the first electrode pad, the second electrode pad, the third electrode pad, and the fourth electrode pad in the first main surface of the film using an ultrasonic welding machine;
a first connection step of removing the insulating coating of the first conductive wire located on the first electrode pad and electrically connecting the thin metal wire that is exposed to the first electrode pad;
a second connection step of removing the insulating coating of the first conductive wire located on the second electrode pad and electrically connecting the thin metal wire that is exposed to the second electrode pad,
a third connection step of removing the insulating coating of the second conductive wire located on the third electrode pad and electrically connecting the thin metal wire that is exposed to the third electrode pad; and
a fourth connection step of removing the insulating coating of the second conductive wire located on the fourth electrode pad and electrically connecting the thin metal wire that is exposed to the fourth electrode pad, wherein
one end connected to the first wiring portion out of both ends of the first end portion and one end connected to the second wiring portion out of both ends of the second end portion are located on a same side with respect to the first electrode pad, the second electrode pad, the third electrode pad, and the fourth electrode pad in plan view,
one end connected to the third wiring portion out of both ends of the third end portion and one end connected to the fourth wiring portion out of both ends of the fourth end portion are located on a same side with respect to the first electrode pad, the second electrode pad, the third electrode pad, and the fourth electrode pad in plan view,
the one ends of the third end portion and the fourth end portion and the one ends of the first end portion and the second end portion are located at positions sandwiching the first electrode pad, the second electrode pad, the third electrode pad, and the fourth electrode pad in plan view,
in the first circuit formation step, the ultrasonic welding machine includes a horn that melts a contact surface of the film with the first conductive wire by applying ultrasonic vibration and that embeds the first conductive wire into the first main surface of the film, and the first conductive wire to be continuously drawn out from a tip of the horn onto the first main surface of the film through an inside of the horn,
in the second circuit formation step, the ultrasonic welding machine includes the horn that melts a contact surface of the film with the second conductive wire by applying ultrasonic vibration and that embeds the second conductive wire into the first main surface of the film, and the second conductive wire to be continuously drawn out from the tip of the horn onto the first main surface of the film through the inside of the horn, and
the first end portion, the second end portion, the third end portion, and the fourth end portion have a length for absorbing a positional deviation of the first electrode pad, the second electrode pad, the third electrode pad, and the fourth electrode pad in the first direction relative to the first circuit and the second circuit.

According to the manufacturing methods provided by the third and fourth aspects, even when the four electrode pads are shifted in the first direction relative to the embedded positions of the four end portions, the first end portion, the second end portion, the third end portion, and the fourth end portion have sections overlapping the four electrode pads, respectively, because the four end portions have a length for absorbing a positional deviation of the four electrode pads in the first direction relative to the first circuit and the second circuit. Therefore, the accuracy in alignment between the first and second circuits and the four electrode pads is increased, whereby the non-defective rate can be improved.

With the method for manufacturing an embedded trace substrate according to the present disclosure, it is possible to improve a non-defective rate by increasing the alignment accuracy between the circuit and the electrode pads.

### BRIEF DESCRIPTION OF THE DRAWINGS

FIGS. 1A, 1B, 1C, 1D, 1E and 1F are schematic perspective views illustrating a first embodiment of a method for manufacturing an embedded trace substrate.

FIG. 2A is a partially enlarged view illustrating an example of a first end portion and a second end portion. FIG. 2B is a cross-sectional view taken along line A-A in FIG. 2A.

FIG. 3 is an enlarged view illustrating a state in which an electrode pad is shifted in a +X direction.

FIG. 4 is an enlarged view illustrating a state in which the electrode pad is shifted in the −X direction.

FIG. 5 is a schematic cross-sectional view of a conductive wire.

FIGS. 6A, 6B, 6C, 6D, 6E and 6F are schematic perspective views illustrating a second embodiment of a method for manufacturing an embedded trace substrate.

FIG. 7A is a partially enlarged view illustrating another example of the first end portion and the second end portion. FIG. 7B is a cross-sectional view taken along line A-A in FIG. 7A.

FIG. 8 is an enlarged view illustrating a state in which the electrode pad is shifted in the +X direction.

FIG. 9 is an enlarged view illustrating a state in which the electrode pad is shifted in the −X direction.

FIGS. 10A, 10B, 10C, 10D, 10E and 10F are schematic perspective views illustrating a third embodiment of a method for manufacturing an embedded trace substrate.

FIGS. 11A, 11B, 11C, 11D, 11E and 11F are schematic perspective views illustrating a fourth embodiment of a method for manufacturing an embedded trace substrate.

FIG. 12A is a schematic plan view illustrating a conventional film heater.

FIG. 12B is a cross-sectional view taken along line A-A in FIG. 12A.

### DETAILED DESCRIPTION OF EMBODIMENTS

### First Embodiment

### Outline of Embedded Trace Substrate

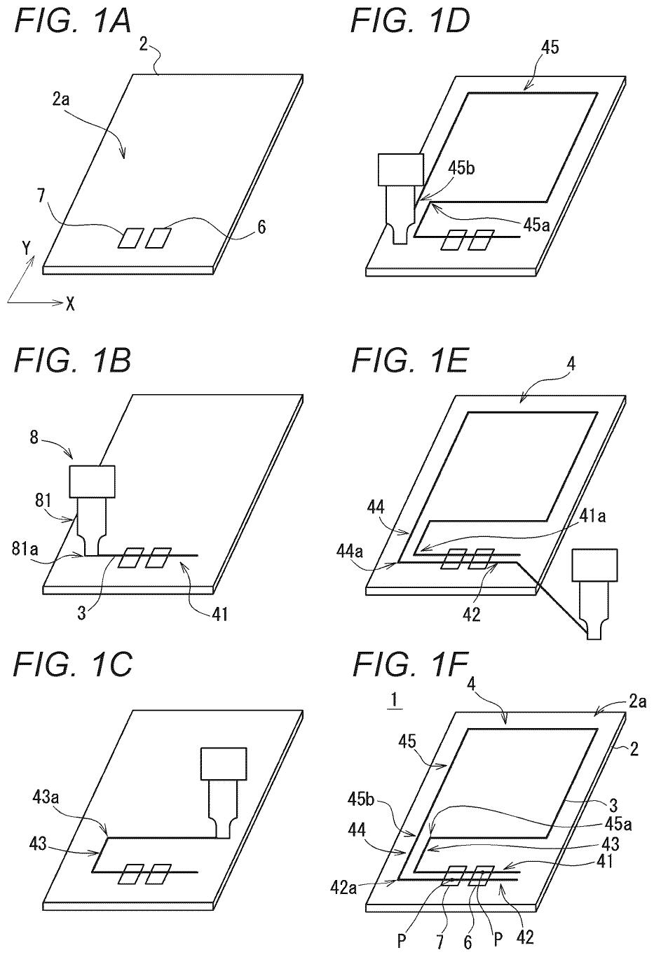

Referring to FIG. 1F, an embedded trace substrate 1 according to the first embodiment includes a film 2, a circuit 4 including a conductive wire 3 disposed on a first main surface 2a of the film 2, a first electrode pad 6, and a second electrode pad 7.

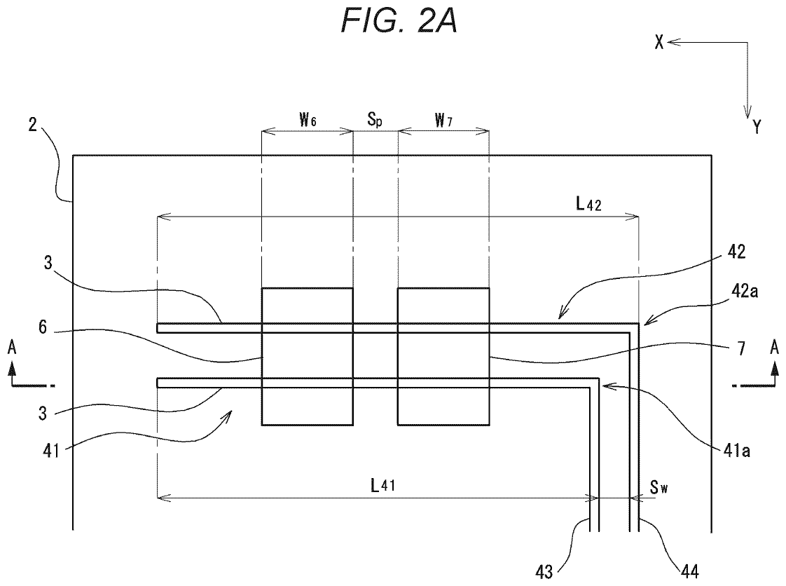

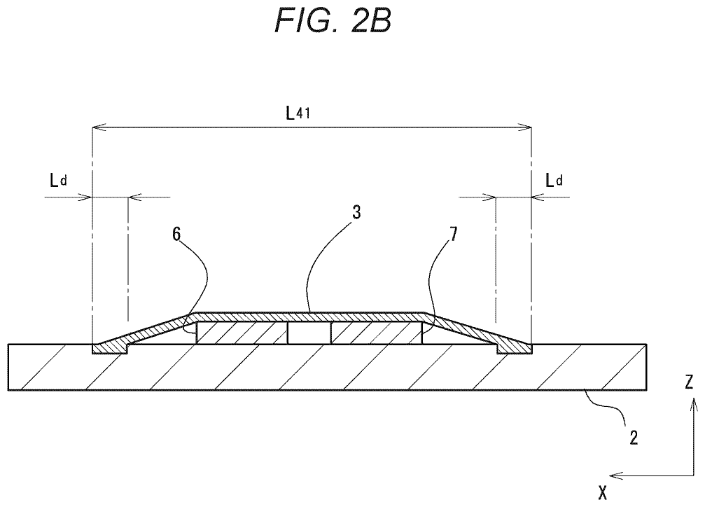

The circuit 4 includes a functional portion 45, a first wiring portion 43, a second wiring portion 44, a first end portion 41, and a second end portion 42. The functional portion 45 has an arbitrary pattern. The first wiring portion 43 is led out from one end 45a of both ends of the functional portion 45. The second wiring portion 44 is led out from another end 45b of both ends of the functional portion 45. The first end portion 41 extends from the first wiring portion 43 in the +X direction (first direction) so as to partly overlap the first electrode pad 6 and the second electrode pad 7. The second end portion 42 extends along the first end portion from the second wiring portion 44 so as to partly overlap the first electrode pad 6 and the second electrode pad 7. Referring to FIG. 2A, one end 41a connected to the first wiring portion 43 out of both ends of the first end portion 41 and one end 42a connected to the second wiring portion 44 out of both ends of the second end portion 42 are disposed on the same side with respect to the first electrode pad 6 and the second electrode pad 7 in plan view. In other words, both the one ends 41a and 42a of the first end portion 41 and the second end portion 42 are disposed at positions in the −X direction with respect to the two electrode pads 6 and 7 in plan view.

The boundary between another end 45b of both ends of the functional portion 45 and the second wiring portion 44 may not be clear as in FIG. 1F, or may be clear as with the one end 45a of both ends of the functional portion 45.

The functional portion 45, the first wiring portion 43, and the second wiring portion 44 are embedded in the first main surface 2a of the film 2. Referring to FIGS. 2A and 2B, the sections of the first end portion 41 and the second end portion 42 overlapping the electrode pads 6 and 7 are not embedded in the first main surface 2a, and the other sections are embedded. More specifically, the sections embedded in the film 2 are, for example, sections indicated by L_{d} as in FIG. 2B. The sections not embedded in the film 2 include sections in contact with the upper surfaces of the electrode pads 6 and 7 and sections inclined between the upper surfaces of the electrode pads 6 and 7 and the embedded section (L_{d}). While the conductive wire 3 needs to straddle the two electrode pads 6 and 7, it is difficult to embed the conductive wire 3 up to the edge of the electrode pads 6 and 7 and extend the conductive wire 3 across the electrode pads 6 and 7. Therefore, inclined sections (sections where the conductive wire 3 are not embedded in the film 2) as illustrated in FIG. 2B is generated.

In the present embodiment, the functional portion 45 is a heat generating portion, and the embedded trace substrate 1 is a film heater. For example, when a positive voltage is applied to the first electrode pad 6 and a negative voltage is applied to the second electrode pad 7, a current is generated in the circuit 4 constituted by the conductive wire 3, and the functional portion 45 generates heat. The functional portion 45 has both ends 45a and 45b connected to the first wiring portion 43 and the second wiring portion 44, respectively, and has a loop-like pattern shape. More specifically, the functional portion 45 has a pattern shape extending in the +X direction from the connection portion (i.e., one end 45a) with the first wiring portion 43, and then extending in the +Y direction, the −X direction, and the −Y direction to reach the connection portion (i.e., another end 45b) with the second wiring portion 44. As described above, the functional portion 45 has the connection portions (i.e., both ends 45a and 45b) with the first wiring portion 43 and the second wiring portion 44, and has an arbitrary pattern extending along an XY plane from the connection portions (i.e., both ends 45a and 45b).

The film 2 can have any shape, and has a rectangular shape in the present embodiment. As the film 2, a transparent film, an opaque film, or a colored transparent film can be used. Examples of a material usable for the film 2 include thermoplastic resins such as an ethylene-based resin, a propylene-based resin, a polyolefin-based resin, a thermoplastic polyester-based resin, a polyamide-based resin, polyvinyl chloride, polycarbonate, and an ABS resin. Two or more kinds of the above-mentioned materials may be used. Inorganic fine powder, an organic filler, a dispersant, an antioxidant, a compatibilizer, an ultraviolet stabilizer, an antiblocking agent, an antistatic agent, or the like can be appropriately added to the film 2. The thickness of the film 2 is, for example, 0.05 mm to 1 mm.

Referring to FIG. 5, the conductive wire 3 is formed by coating a thin metal wire 33 with an insulating coating layer 34. Examples of materials usable for the thin metal wire 33 include a material having conductivity such as copper, iron, gold, copper nickel, nickel chromium, or iron nickel chromium. From the viewpoint of electric resistance, durability, and cost, it is preferable to use copper or a copper alloy obtained by combining zinc, lead, tin, silver, aluminum, nickel, beryllium, zirconium, or the like alone with copper or combining a plurality of the above-mentioned materials with copper. The diameter of the thin metal wire 33 is, for example, 0.01 mm to 0.5 mm.

The insulating coating layer 34 is an insulating resin, and examples of usable resins include polyester, polyethylene, polyurethane, polyvinyl chloride, polyamide, polyimide, polyesterimide, polyamideimide, and fluororesin. The diameter of the conductive wire 3 is, for example, 0.05 mm to 0.3 mm.

Examples of materials usable for the two electrode pads 6 and 7 include a material having conductivity such as copper, phosphor bronze, brass, a Corson alloy, nickel, or molybdenum. A material obtained by plating the above-mentioned material as a base material with nickel, tin, gold, silver, copper, or the like may be used. The size of the electrode pads 6 and 7 is, for example, 5 mm×10 mm. The thickness is, for example, 0.1 mm.

In the present embodiment, the electrode pads 6 and 7 have a quadrangular shape, but the present invention is not limited thereto. The electrode pads 5 and 6 may have, for example, a polygonal shape other than the quadrangular shape, a circular shape, an elliptical shape, an L shape, or the like.

### Method for Manufacturing Embedded Trace Substrate

An embodiment of a method for manufacturing the embedded trace substrate 1 described above will be described with reference to FIGS. 1A to 1F.

The method for manufacturing the embedded trace substrate 1 includes a preparation step (not illustrated) of preparing a film 2, an arrangement step (FIG. 1A) of arranging a first electrode pad 6 and a second electrode pad 7 at the peripheral edge of a first main surface 2a of the film 2, a circuit formation step (FIGS. 1B to 1E) of forming a circuit 4 using an ultrasonic welding machine 8, and first and second connection steps (FIG. 1F) of electrically connecting a first end portion 41 and a second end portion 42 of the circuit 4 to the electrode pads 6 and 7.

In the preparation step, the film 2 may be fixed on a stage (not illustrated). In addition, a jig (not illustrated) may be used to facilitate alignment of the film 2. In the arrangement step, the first electrode pad 6 and the second electrode pad 7 are arranged at the peripheral edge of the first main surface 2a of the film 2. In other words, the first electrode pad 5 and the second electrode pad 6 are aligned in the X direction along one side parallel to the X direction (first direction) of the film 2. The two electrode pads 6 and 7 have a quadrangular shape and are arranged along the X direction in parallel to each other with a space therebetween. Each of the two electrode pads 6 and 7 serves as a terminal portion of the embedded trace substrate 1. The two electrode pads 6 and 7 can be fixed on the first main surface 2a using, for example, an adhesive.

Referring to FIG. 1B, the ultrasonic welding machine 8 used in the circuit formation step includes an oscillator (not illustrated) that generates ultrasonic vibration, a horn 81 that propagates the ultrasonic vibration from the oscillator, and the conductive wire 3. The horn 81 can melt a contact surface of the film 2 with the conductive wire 3 by applying ultrasonic vibration and embed the conductive wire 3 in the first main surface 2a of the film 2. The conductive wire 3 passes through the inside of the horn 81 and is continuously drawn out from a tip 81a of the horn 81 onto the first main surface 2a of the film 2.

In the circuit formation step, first, the conductive wire 3 is drawn out from the horn 81 by a predetermined length, is embedded in the first main surface 2a of the film 2, is extended so as to straddle the first electrode pad 6 and the second electrode pad 7 in the −X direction (first direction), and is embedded into the first main surface 2a of the film 2 after straddling, whereby a first end portion 41 is formed, as illustrated in FIG. 1B. At this time, the conductive wire 3 overlapping the first electrode pad 6 and the second electrode pad 7 is not embedded in the first main surface 2a and is in contact with the upper surfaces of the first electrode pad 6 and the second electrode pad 7.

Next, as illustrated in FIGS. 1C and 1D, the conductive wire 3 is drawn out by a predetermined length from an end point of the first end portion 41 that has been embedded in the +Y direction and is embedded in the first main surface 2a to form a first wiring portion 43. Next, the conductive wire 3 is drawn out from an end point 43a of the first wiring portion 43 that has been embedded by a predetermined length and is embedded in the first main surface 2a in an arbitrary pattern extending in the XY plane to form a functional portion 45. The end point 43a of the first wiring portion 43 that has been embedded serves as a start point of the functional portion 45. In other words, the end point 43a of the first wiring portion 43 serves as one end 45a of both ends of the functional portion 45 (see FIG. 1D).

Next, as illustrated in FIG. 1E, the conductive wire 3 is drawn out from the horn 81 by a predetermined length and is embedded in the first main surface 2a so as to extend in the −Y direction from an end point (i.e., another end 45b) of the functional portion 45, by which a second wiring portion 44 is formed. The end point of the functional portion 45 serves as a start point of the second wiring portion 44 and as another end 45b of both ends of the functional portion 45. The conductive wire 3 is drawn out from an end point 44a of the second wiring portion 44 that has been embedded by a predetermined length, is embedded in the first main surface 2a along the first end portion 41, is extended so as to straddle the first electrode pad 6 and the second electrode pad 7, and is embedded into the first main surface 2a of the film 2 after straddling, whereby a second end portion 42 is formed. At this time, the conductive wire 3 overlapping the first electrode pad 6 and the second electrode pad 7 is not embedded in the first main surface 2a and is in contact with the upper surfaces of the first electrode pad 6 and the second electrode pad 7. After the second end portion 42 is formed, the conductive wire 3 is cut at an end point of the second end portion 42 that has been embedded. As a cutting method, for example, a cutter or a nipper can be used.

Finally, in the first and second connection steps, the two electrode pads 6 and 7 and the conductive wire 3 located on (in contact with the upper surfaces of) the two electrode pads 6 and 7 are electrically connected to each other as indicated by a point P in FIG. 1F. A known metal bonding technique such as welding (resistance welding, ultrasonic welding, laser welding, or the like), soldering, brazing, or the like can be used for the connection. With any of the above-mentioned connection methods, the insulating coating layer 34 at the first end portion 41 and the second end portion 42 is melted by heat to expose the thin metal wire 33, and the exposed thin metal wire 33 can be electrically connected to the upper surfaces of the electrode pads 6 and 7. The first connection step and the second connection step may be performed separately, but it is preferable to perform the first connection step and the second connection step simultaneously because the production efficiency is improved.

In this way, the embedded trace substrate 1 can be obtained.

Referring to FIG. 2A, the first end portion 41 and the second end portion 42 have lengths L₄₁ and L₄₂, respectively. Here, as illustrated in FIG. 2B, the first end portion 41 straddles the electrode pads 6 and 7, and both ends thereof are embedded in the film 2. Each of the electrode pads 6 and 7 cannot be disposed at a position where the conductive wire 3 is to be embedded, and thus, when the embedded length is L_{d}, a positional-deviation allowable length of each of the electrode pads 6 and 7 is indicated as L₄₁−2L_{d}. That is, the length L₄₁−2L_{d} is a substantial length of the first end portion 41 that absorbs the positional deviation in the X direction (first direction) between each of the electrode pads 6 and 7 and the circuit 4. As for the length L₄₂ of the second end portion 42, since the second electrode pad 7 cannot be disposed beyond the one end 41a of the first end portion 41 in the −X direction, the substantial positional-deviation allowable length is L₄₁−2L_{d}.

FIGS. 2A and 2B illustrate a state in which there is no positional deviation between the first and second electrode pads 6 and 7 and the first and second end portions 41 and 42.

For example, when the widths W₆ and W₇ of the electrode pads 6 and 7 are 5 mm, respectively, and the interval Sp between the electrode pads 6 and 7 is 2 mm, the length L₄₁ of the first end portion 41 can be 22 mm, the length L₄₂ of the second end portion 42 can be 27 mm, and the distance Sw between the conductive wires can be 5 mm.

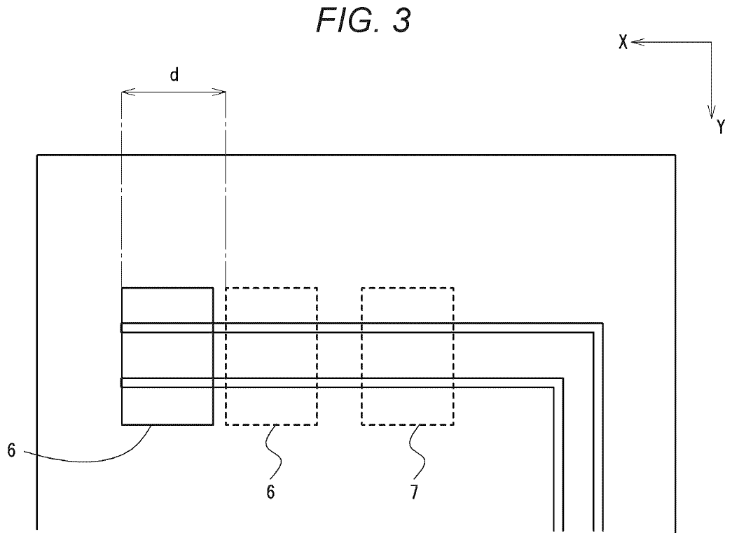

Even when the electrode pads 6 and 7 are shifted by d in the +X direction as illustrated in FIG. 3, the positional deviation of the electrode pads 6 and 7 can be absorbed because of the first end portion 41 and the second end portion 42 respectively having the length L₄₁ and L₄₂ larger than d. Strictly speaking, the positional deviation amount of the first electrode pad 6 is a value (d−L_{d}) obtained by subtracting the embedded length L_{d} from d. In FIG. 3, only the first electrode pad 6 that has been shifted is indicated by a solid line for convenience.

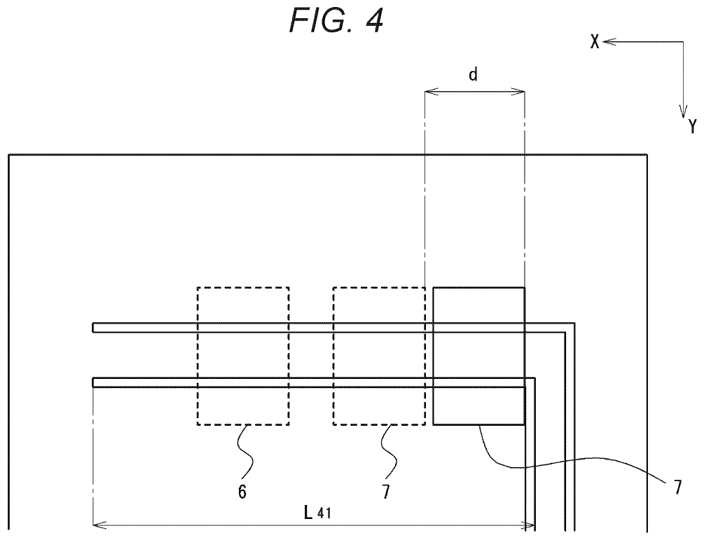

Further, even when the electrode pads 6 and 7 are shifted by d in the −X direction as illustrated in FIG. 4, the positional deviation of the electrode pads 6 and 7 can be absorbed because of the first end portion 41 and the second end portion 42 respectively having the length L₄₁ and L₄₂ larger than d. In FIG. 4, only the second electrode pad 7 that has been shifted is indicated by a solid line for convenience.

As described above, even when the electrode pads 6 and 7 are shifted by d in the X direction relative to the film 2, the first end portion 41 and the second end portion 42 overlap the electrode pads 6 and 7, because the first end portion 41 and the second end portion 42 respectively have the lengths L₄₁ and L₄₂. Therefore, it is not necessary to consider the positional deviation of the electrode pads 6 and 7 for the embedded positions of the first end portion 41 and the second end portion 42. That is, it is only sufficient that the first end portion 41 and the second end portion 42 are embedded at the same position every time the embedded trace substrate 1 is manufactured. The first and second end portions 41 and 42 can be aligned with the electrode pads 6 and 7 without considering the positional deviation of the electrode pads 6 and 7, so that the non-defective rate can be improved.

### Second Embodiment

### (Outline of Embedded Trace Substrate)

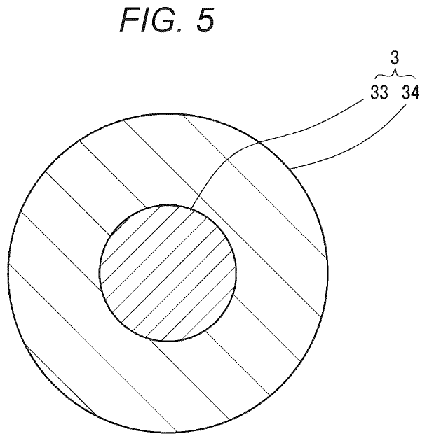

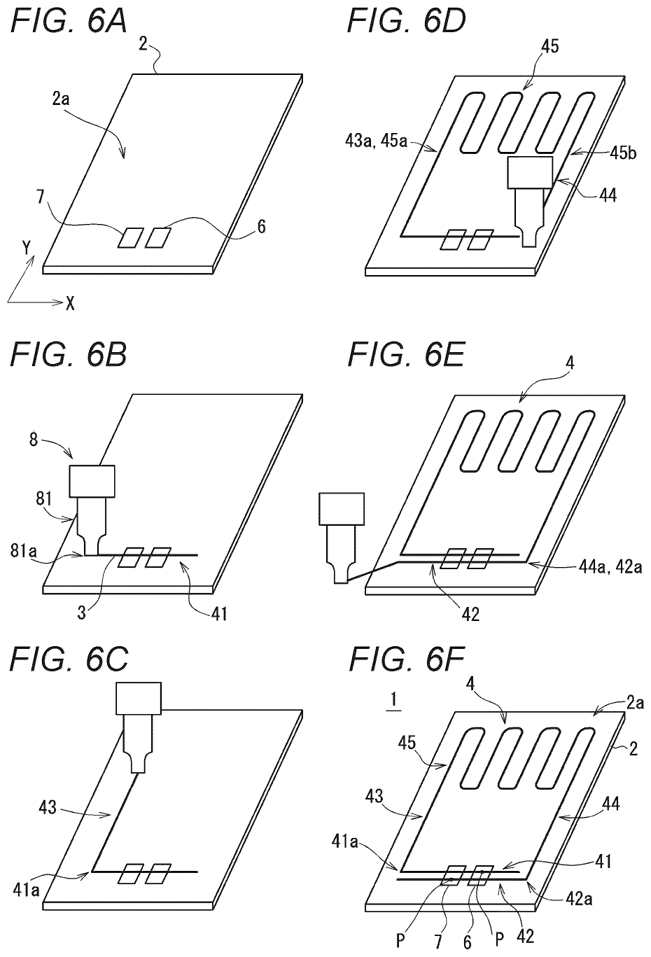

Referring to FIG. 6F, an embedded trace substrate 1 according to the second embodiment includes a film 2, a circuit 4 including a conductive wire 3 disposed on a first main surface 2a of the film 2, a first electrode pad 6, and a second electrode pad 7. The second embodiment differs from the first embodiment in the pattern shape of a functional portion 45 and the positions of one end 41a of a first end portion 41 and one end 42a of a second end portion 42. The other configurations are the same as those described in the first embodiment, and thus the description thereof will be omitted. The differences from the first embodiment will be mainly described below.

In the second embodiment, the pattern of the functional portion 45 has a meander shape. Note that the boundary between one end 45a of both ends of the functional portion 45 and the first wiring portion 43 and the boundary between another end 45b of both ends of the functional portion 45 and the second wiring portion 44 may not be clear as in FIG. 6D, or may be clear with the ends 45a and 45b as a boundary.

### (Method for Manufacturing Embedded Trace Substrate)

An embodiment of a method for manufacturing the embedded trace substrate 1 described above will be described with reference to FIGS. 6A to 6F.

The method for manufacturing the embedded trace substrate 1 includes a preparation step (not illustrated) of preparing a film 2, an arrangement step (FIG. 6A) of arranging a first electrode pad 6 and a second electrode pad 7 at the peripheral edge of a first main surface 2a of the film 2, a circuit formation step (FIGS. 6B to 6E) of forming a circuit 4 using an ultrasonic welding machine 8, and first and second connection steps (FIG. 6F) of electrically connecting a first end portion 41 and a second end portion 42 of the circuit 4 to the electrode pads 6 and 7. Since the preparation step, the arrangement step, a part of the circuit formation step (FIG. 6B), and the first and second connection steps (FIG. 6F) are similar to those of the first embodiment, the description thereof will be omitted, and the method will be described from FIG. 6C.

As illustrated in FIGS. 6C and 6D, the conductive wire 3 is drawn out by a predetermined length from an end point 41a of the first end portion 41 that has been embedded in the +Y direction and is embedded in the first main surface 2a to form a first wiring portion 43. Next, the conductive wire 3 is drawn out by a predetermined length from an end point 43a of the first wiring portion 43 that has been embedded and is embedded in the first main surface 2a in a meander shape extending in the XY plane to form a functional portion 45. The end point 43a of the first wiring portion 43 that has been embedded serves as a start point of the functional portion 45. In other words, the end point 43a of the first wiring portion 43 serves as one end 45a of both ends of the functional portion 45 (see FIG. 6D).

Next, as illustrated in FIG. 6D, the conductive wire 3 is drawn out from the horn 81 by a predetermined length and is embedded in the first main surface 2a so as to extend in the −Y direction from an end point (i.e., another end 45b) of the functional portion 45, by which a second wiring portion 44 is formed. The end point of the functional portion 45 serves as a start point of the second wiring portion 44 and as another end 45b of both ends of the functional portion 45.

Then, the conductive wire 3 is drawn out by a predetermined length from an end point 44a of the second wiring portion 44 that has been embedded, is embedded in the first main surface 2a along the first end portion 41, is extended so as to straddle the first electrode pad 6 and the second electrode pad 7, and is embedded into the first main surface 2a of the film 2 after straddling, whereby a second end portion 42 is formed, as illustrated in FIG. 6E. At this time, the conductive wire 3 overlapping the first electrode pad 6 and the second electrode pad 7 is not embedded in the first main surface 2a and is in contact with the upper surfaces of the first electrode pad 6 and the second electrode pad 7. After the second end portion 42 is formed, the conductive wire 3 is cut at an end point of the second end portion 42 that has been embedded.

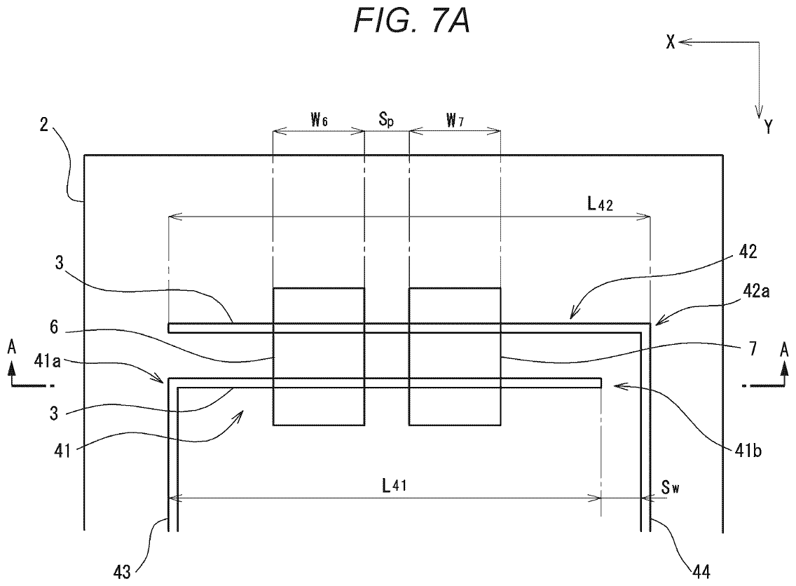

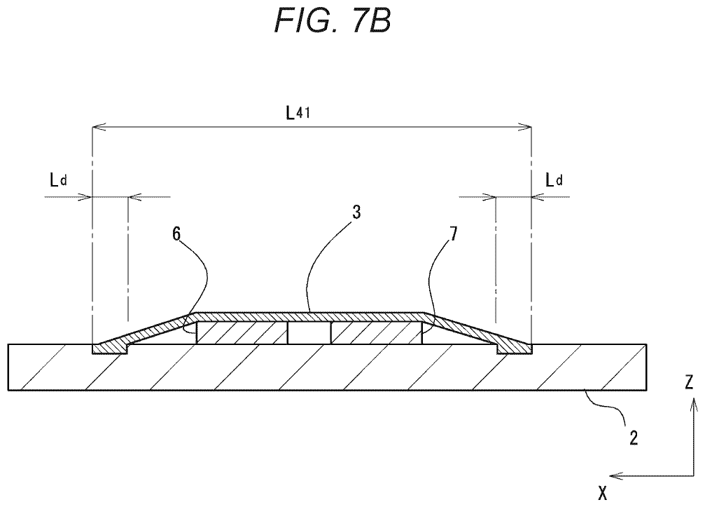

Referring to FIG. 7A, one end 41a connected to the first wiring portion 43 out of both ends of the first end portion 41 and one end 42a connected to the second wiring portion 44 out of both ends of the second end portion 42 are disposed at positions sandwiching the first electrode pad 6 and the second electrode pad 7 in plan view. In other words, the one end 41a of the first end portion 41 is disposed at a position in the +X direction with respect to the electrode pads 6 and 7 in plan view, and the one end 42a of the second end portion 42 is disposed at a position in the −X direction with respect to the electrode pads 6 and 7 in plan view.

The first end portion 41 and the second end portion 42 have lengths L₄₁ and L₄₂, respectively (L₄₁<L₄₂). Here, as illustrated in FIG. 7B, the first end portion 41 straddles the electrode pads 6 and 7, and both ends thereof are embedded in the film 2. Each of the electrode pads 6 and 7 cannot be disposed at a position where the conductive wire 3 is to be embedded, and thus, when the embedded length is L_{d}, a positional-deviation allowable length of each of the electrode pads 6 and 7 is indicated as L₄₁−−2L_{d}. That is, the length L₄₁−2L_{d} is a substantial length of the first end portion 41 that absorbs the positional deviation in the X direction (first direction) between each of the electrode pads 6 and 7 and the circuit 4. As for the length L₄₂ of the second end portion 42, since the second electrode pad 7 cannot be disposed beyond another end 41b of the first end portion 41 in the −X direction, the substantial positional-deviation allowable length is L₄₁−2L_{d}.

FIGS. 7A and 7B illustrate a state in which there is no positional deviation between the first and second electrode pads 6 and 7 and the first and second end portions 41 and 42.

For example, when the widths W₆ and W₇ of the electrode pads 6 and 7 are 5 mm, respectively, and the interval S_{P} between the electrode pads 6 and 7 is 2 mm, the length L₄₁ of the first end portion 41 can be 22 mm, the length L₄₂ of the second end portion 42 can be 27 mm, and the distance Sw between the conductive wires can be 5 mm.

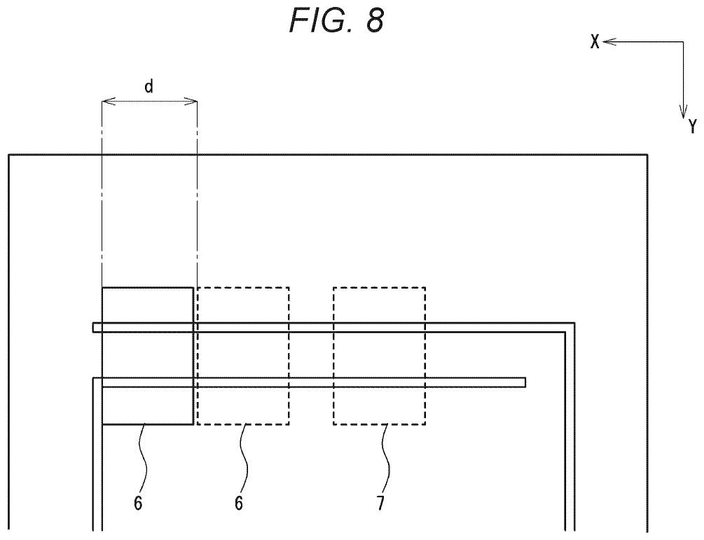

Even when the electrode pads 6 and 7 are shifted by d in the +X direction as illustrated in FIG. 8, the positional deviation of the electrode pads 6 and 7 can be absorbed because of the first end portion 41 and the second end portion 42 respectively having the length L₄₁ and L₄₂ larger than d. In FIG. 8, only the first electrode pad 6 that has been shifted is indicated by a solid line for convenience.

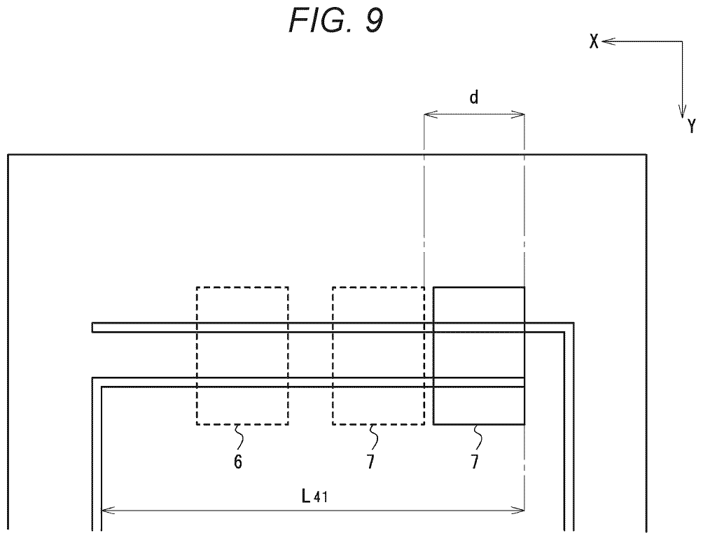

Further, even when the electrode pads 6 and 7 are shifted by d in the −X direction as illustrated in FIG. 9, the positional deviation of the electrode pads 6 and 7 can be absorbed because of the first end portion 41 and the second end portion 42 respectively having the length L₄₁ and L₄₂ larger than d. At that time, the positional deviation amount of the second electrode pad 7 is a value (d−L_{d}) obtained by subtracting the embedded length L_{d} from d. In FIG. 9, only the second electrode pad 7 that has been shifted is indicated by a solid line for convenience.

As described above, even when the electrode pads 6 and 7 are shifted by d in the X direction relative to the film 2, the first end portion 41 and the second end portion 42 overlap the electrode pads 6 and 7, because the first end portion 41 and the second end portion 42 respectively have the lengths L₄₁ and L₄₂. Therefore, it is not necessary to consider the positional deviation of the electrode pads 6 and 7 for the embedded positions of the first end portion 41 and the second end portion 42. That is, it is only sufficient that the first end portion 41 and the second end portion 42 are embedded at the same position every time the embedded trace substrate 1 is manufactured. The first and second end portions 41 and 42 can be aligned with the electrode pads 6 and 7 without considering the positional deviation of the electrode pads 6 and 7, so that the non-defective rate can be improved.

### Third Embodiment

### (Outline of Embedded Trace Substrate)

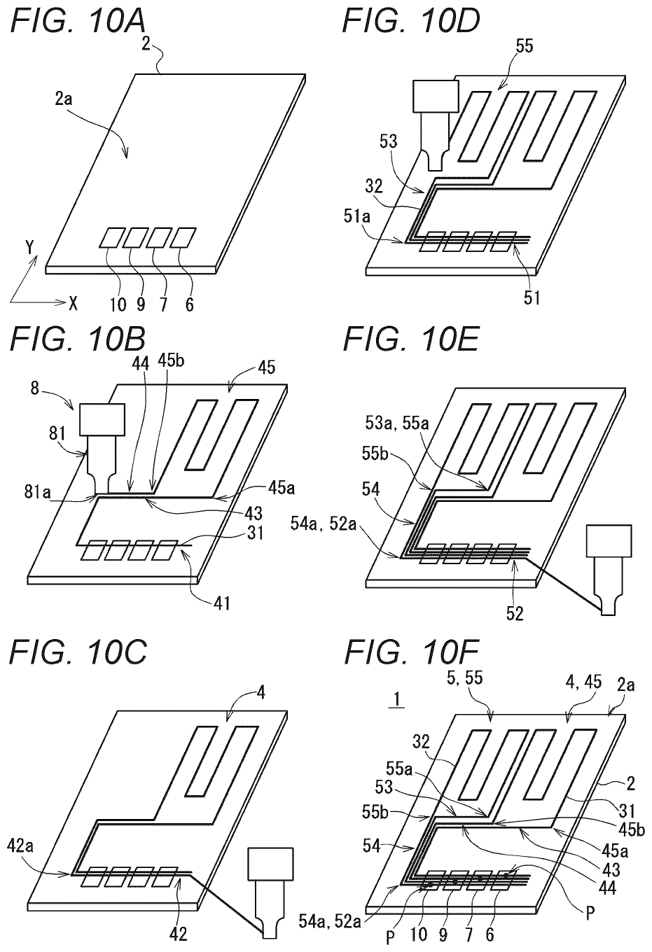

Referring to FIG. 10F, an embedded trace substrate 1 according to the third embodiment includes a film 2, and a first circuit 4 including a first conductive wire 31, a second circuit 5 including a second conductive wire 32, a first electrode pad 6, a second electrode pad 7, a third electrode pad 9, and a fourth electrode pad 10 which are disposed on a first main surface 2a of the film 2.

The first circuit 4 includes a first functional portion 45, a first wiring portion 43, a second wiring portion 44, a first end portion 41, and a second end portion 42.

The first functional portion 45 has an arbitrary pattern. The first wiring portion 43 is led out from one end 45a of both ends of the first functional portion 45. The second wiring portion 44 is led out from another end 45b of both ends of the first functional portion 45. The first end portion 41 extends from the first wiring portion 43 in the +X direction (first direction) so as to partly overlap the four electrode pads 6, 7, 9, and 10. The second end portion 42 extends from the second wiring portion 44 along the first end portion 41 so as to partly overlap the four electrode pads 6, 7, 9, and 10.

The second circuit 5 includes a second functional portion 55, a third wiring portion 53, a fourth wiring portion 54, a third end portion 51, and a fourth end portion 52. The second functional portion 55 has an arbitrary pattern. The third wiring portion 53 is led out from one end 55a of both ends of the second functional portion 55. The fourth wiring portion 54 is led out from another end 55b of both ends of the second functional portion 55. The third end portion 51 extends from the third wiring portion 53 in the +X direction (first direction) so as to partly overlap the four electrode pads 6, 7, 9, and 10. The fourth end portion 52 extends from the fourth wiring portion 54 along the third end portion 51 so as to partly overlap the four electrode pads 6, 7, 9, and 10.

One end 41a connected to the first wiring portion 43 out of both ends of the first end portion 41, one end 42a connected to the second wiring portion 44 out of both ends of the second end portion 42, one end 51a connected to the third wiring portion 53 out of both ends of the third end portion 51, and one end 52a connected to the fourth wiring portion 54 out of both ends of the fourth end portion 52 are disposed on the same side with respect to the four electrode pads 6, 7, 9, and 10 in plan view. In other words, the one ends 41a, 42a, 51a, and 52a of the four end portions 41, 42, 51, and 52 are located at positions in the −X direction with respect to the four electrode pads 6, 7, 9, and 10 in plan view.

The boundary between another end 55b of both ends of the second functional portion 55 and the fourth wiring portion 54 may not be clear as in FIG. 10E, or may be clear as with the one end 55a of both ends of the second functional portion 55.

### (Method for Manufacturing Embedded Trace Substrate)

An embodiment of a method for manufacturing the embedded trace substrate 1 described above will be described with reference to FIGS. 10A to 10F.

The method for manufacturing the embedded trace substrate 1 includes a preparation step (not illustrated) of preparing a film 2, an arrangement step (FIG. 10A) of arranging a first electrode pad 6, a second electrode pad 7, a third electrode pad 9, and a fourth electrode pad 10 at the peripheral edge of a first main surface 2a of the film 2, a first circuit formation step (FIGS. 10B and 10C) of forming a first circuit 4 using an ultrasonic welding machine 8, a second circuit formation step (FIGS. 10D and 10E) of forming a second circuit 5 using the ultrasonic welding machine 8, and first to fourth connection steps (FIG. 10F) of electrically connecting a first end portion 41, a second end portion 42, a third end portion 51, and a fourth end portion 52 to the four electrode pads 6, 7, 9, and 10, respectively. Since the preparation step, the arrangement step, the first circuit formation step (FIGS. 10B and 10C), and the first to fourth connection steps (FIG. 10F) are similar to those of the first embodiment, the description thereof will be omitted, and the second circuit formation step (FIGS. 10D and 10E) will be described.

First, the second conductive wire 32 is drawn out from the horn 81 by a predetermined length, is embedded in the first main surface 2a of the film 2, is extended so as to straddle the four electrode pads 6, 7, 9, and 10 in the −X direction (first direction), and is embedded into the first main surface 2a of the film 2 after straddling, whereby a third end portion 51 is formed. The third end portion 51 is formed in parallel with the first end portion 41 and the second end portion 42.

Next, the second conductive wire 32 is drawn out in the +Y direction by a predetermined length from an end point of the third end portion 51 that has been embedded and is embedded in the first main surface 2a to form a third wiring portion 53. Next, the second conductive wire 32 is drawn out by a predetermined length from an end point 53a of the third wiring portion 53 that has been embedded and is embedded in the first main surface 2a in an arbitrary pattern extending in the XY plane to form a second functional portion 55. The end point 53a of the third wiring portion 53 that has been embedded serves as a start point of the second functional portion 55. In other words, the end point 53a of the third wiring portion 53 serves as one end 55a of both ends of the second functional portion 55 (see FIG. 10E).

Next, as illustrated in FIG. 10E, the second conductive wire 32 is drawn out from the horn 81 by a predetermined length and is embedded in the first main surface 2a so as to extend in the −Y direction from an end point 55b of the second functional portion 55, by which a fourth wiring portion 54 is formed. The end point of the second functional portion 55 serves as a start point of the fourth wiring portion 54 and as another end 55b of both ends of the second functional portion 55. The second conductive wire 32 is drawn out from an end point 54a of the fourth wiring portion 54 that has been embedded by a predetermined length, is embedded in the first main surface 2a along the third end portion 51, is extended so as to straddle the four electrode pads 6, 7, 9, and 10 in the +X direction, and is embedded into the first main surface 2a of the film 2 after straddling, whereby a fourth end portion 52 is formed.

In the third embodiment, the one ends 41a, 42a, 51a, and 52a of the four end portions 41, 42, 51, and 52 are disposed on the same side with respect to the four electrode pads 6, 7, 9, and 10 in plan view as in the first embodiment. Therefore, the same effects as those of the first embodiment are obtained. That is, it is only sufficient that the four end portions 41, 42, 51, and 52 are embedded at the same position every time the embedded trace substrate 1 is manufactured. The four end portions 41, 42, 51, and 52 can be aligned with the four electrode pads 6, 7, 9, and 10 without considering the positional deviation of the four electrode pads 6, 7, 9, and 10, so that the non-defective rate can be improved.

### Fourth Embodiment

### (Outline of Embedded Trace Substrate)

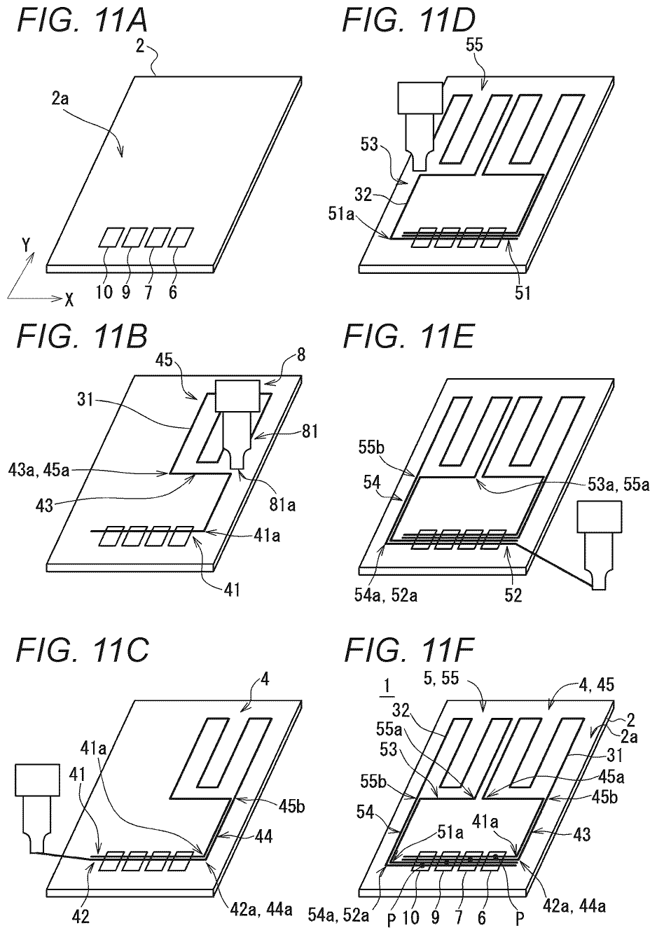

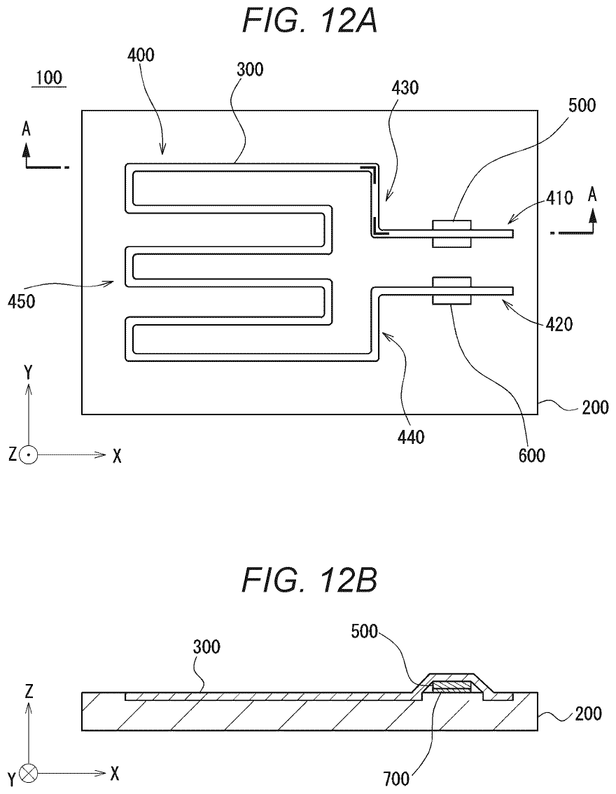

Referring to FIG. 11F, an embedded trace substrate 1 according to the fourth embodiment includes a film 2, a first circuit 4 including a first conductive wire 31 disposed on a first main surface 2a of the film 2, a second circuit 5 including a second conductive wire 32, a first electrode pad 6, a second electrode pad 7, a third electrode pad 9, and a fourth electrode pad 10. The fourth embodiment differs from the third embodiment in the positions of one ends 41a and 42a of two end portions 41 and 42 and in the positions of one ends 51a and 52a of two end portions 51 and 52. The other configurations are the same as those described in the third embodiment, and thus the description thereof will be omitted. The differences from the third embodiment will be mainly described below.

Referring to FIG. 11C, one end 41a connected to the first wiring portion 43 out of both ends of the first end portion 41 and one end 42a connected to the second wiring portion 44 out of both ends of the second end portion 42 are located at positions in the +X direction with respect to the four electrode pads 6, 7, 9, and 10 in plan view.

Referring to FIG. 11F, one end 51a connected to the third wiring portion 53 out of both ends of the third end portion 51 and one end 52a connected to the fourth wiring portion 54 out of both ends of the fourth end portion 52 are located at positions in the −X direction with respect to the four electrode pads 6, 7, 9, and 10 in plan view. That is, the one ends 41a and 42a of the first end portion 41 and the second end portion 42 and the one ends 51a and 52a of the third end portion 51 and the fourth end portion 52 are disposed at positions sandwiching the four electrode pads 6, 7, 9, and 10.

### (Method for Manufacturing Embedded Trace Substrate)

An embodiment of a method for manufacturing the embedded trace substrate 1 described above will be described with reference to FIGS. 11A to 11F.

The method for manufacturing the embedded trace substrate 1 includes an arrangement step (FIG. 11A) of arranging a first electrode pad 6, a second electrode pad 7, a third electrode pad 9, and a fourth electrode pad 10 at the peripheral edge of a first main surface 2a of the film 2, a first circuit formation step (FIGS. 11B and 11C) of forming a first circuit 4 using an ultrasonic welding machine 8, a second circuit formation step (FIGS. 11D and 11E) of forming a second circuit 5 using the ultrasonic welding machine 8, and first to fourth connection steps (FIG. 11F) of electrically connecting a first end portion 41, a second end portion 42, a third end portion 51, and a fourth end portion 52 to the four electrode pads 6, 7, 9, and 10, respectively. Since the preparation step, the arrangement step, the second circuit formation step (FIGS. 11D and 11E), and the first to fourth connection steps (FIG. 11F) are similar to those of the third embodiment, the description thereof will be omitted, and the first circuit formation step (FIGS. 11B and 11C) will be described.

First, the first conductive wire 31 is drawn out from the horn 81 by a predetermined length, is embedded in the first main surface 2a of the film 2, is extended so as to straddle the four electrode pads 6, 7, 9, and 10 in the +X direction (first direction), and is embedded into the first main surface 2a of the film 2 after straddling, whereby a first end portion 41 is formed.

Next, the first conductive wire 31 is drawn out by a predetermined length from an end point of the first end portion 41 that has been embedded in the +Y direction and is embedded in the first main surface 2a to form a first wiring portion 43. Next, the first conductive wire 31 is drawn out from an end point 43a of the first wiring portion 43 that has been embedded by a predetermined length and is embedded in the first main surface 2a in an arbitrary pattern extending in the XY plane to form a first functional portion 45. The end point 43a of the first wiring portion 43 that has been embedded serves as a start point of the first functional portion 45. In other words, the end point 43a of the first wiring portion 43 serves as one end 45a of both ends of the first functional portion 45 (see FIG. 11B).

Next, as illustrated in FIG. 11C, the first conductive wire 31 is drawn out from the horn 81 by a predetermined length and is embedded in the first main surface 2a so as to extend in the −Y direction from an end point (e.g., another end 45b) of the first functional portion 45, by which a second wiring portion 44 is formed. The end point of the first functional portion 45 serves as a start point of the second wiring portion 44 and as another end 45b of both ends of the first functional portion 45. The first conductive wire 31 is drawn out from an end point 44a of the second wiring portion 44 that has been embedded by a predetermined length, is embedded in the first main surface 2a along the first end portion 41, is extended so as to straddle the four electrode pads 6, 7, 9, and 10 in the −X direction, and is embedded into the first main surface 2a of the film 2 after straddling, whereby a second end portion 42 is formed. The second end portion 42 is formed in parallel with the first end portion 41.

In the fourth embodiment, the one ends 41a and 42a of the two end portions 41 and 42 are disposed on the same side (+X) with respect to the four electrode pads 6, 7, 9, and 10 in plan view as in the second embodiment. In addition, the one ends 51a and 52a of the two end portions 51 and 52 are disposed on the same side (−X) with respect to the four electrode pads 6, 7, 9, and 10 in plan view. That is, two sets of one ends (a set of 41a and 42a and a set of 51a and 52a) are arranged at positions sandwiching the four electrode pads 6, 7, 9, and 10 in plan view. Therefore, the same effects as those of the second embodiment are obtained. That is, it is only sufficient that the four end portions 41, 42, 51, and 52 are embedded at the same position every time the embedded trace substrate 1 is manufactured. The four end portions 41, 42, 51, and 52 can be aligned with the four electrode pads 6, 7, 9, and 10 without considering the positional deviation of the four electrode pads 6, 7, 9, and 10, so that the non-defective rate can be improved.

1. A method for manufacturing an embedded trace substrate, the method comprising:
preparing a film;
arranging a first electrode pad and a second electrode pad at a peripheral edge of a first main surface of the film along a first direction so as to be parallel to each other and spaced from each other;
forming, on the first main surface of the film, a circuit including a conductive wire obtained by coating a thin metal wire with an insulating coating, the circuit having a functional portion having an arbitrary pattern, a first wiring portion led out from one end of both ends of the functional portion to an outside of the functional portion, a second wiring portion led out from another end of both ends of the functional portion to the outside of the functional portion, a first end portion extending in the first direction from the first wiring portion so as to partly overlap the first electrode pad and the second electrode pad, and a second end portion extending along the first end portion from the second wiring portion so as to partly overlap the first electrode pad and the second electrode pad, the circuit being formed by embedding the functional portion, the first wiring portion, the second wiring portion, and sections of the first end portion and the second end portion not overlapping the first electrode pad and the second electrode pad in the first main surface of the film using an ultrasonic welding machine;
removing the insulating coating of the conductive wire located on the first electrode pad and electrically connecting the thin metal wire that is exposed to the first electrode pad; and
removing the insulating coating of the conductive wire located on the second electrode pad and electrically connecting the thin metal wire that is exposed to the second electrode pad, wherein
one end connected to the first wiring portion out of both ends of the first end portion and one end connected to the second wiring portion out of both ends of the second end portion are located on a same side with respect to the first electrode pad and the second electrode pad in plan view,
the ultrasonic welding machine includes a horn that melts a contact surface of the film with the conductive wire by applying ultrasonic vibration and that embeds the conductive wire into the first main surface of the film, and the conductive wire to be continuously drawn out from a tip of the horn onto the first main surface of the film through an inside of the horn, and
the first end portion and the second end portion have a length for absorbing a positional deviation of the first electrode pad and the second electrode pad in the first direction relative to the circuit.

2. A method for manufacturing an embedded trace substrate, the method comprising:
preparing a film;
arranging a first electrode pad and a second electrode pad at a peripheral edge of a first main surface of the film along a first direction so as to be parallel to each other and spaced from each other;
forming, on the first main surface of the film, a circuit including a conductive wire obtained by coating a thin metal wire with an insulating coating, the circuit having a functional portion having an arbitrary pattern, a first wiring portion led out from one end of both ends of the functional portion to an outside of the functional portion, a second wiring portion led out from another end of both ends of the functional portion to the outside of the functional portion, a first end portion extending in the first direction from the first wiring portion so as to partly overlap the first electrode pad and the second electrode pad, and a second end portion extending along the first end portion from the second wiring portion so as to partly overlap the first electrode pad and the second electrode pad, the circuit being formed by embedding the functional portion, the first wiring portion, the second wiring portion, and sections of the first end portion and the second end portion not overlapping the first electrode pad and the second electrode pad in the first main surface of the film using an ultrasonic welding machine;
removing the insulating coating of the conductive wire located on the first electrode pad and electrically connecting the thin metal wire that is exposed to the first electrode pad; and
removing the insulating coating of the conductive wire located on the second electrode pad and electrically connecting the thin metal wire that is exposed to the second electrode pad, wherein
one end connected to the first wiring portion out of both ends of the first end portion and one end connected to the second wiring portion out of both ends of the second end portion are located at positions sandwiching the first electrode pad and the second electrode pad in plan view,
the ultrasonic welding machine includes a horn that melts a contact surface of the film with the conductive wire by applying ultrasonic vibration and that embeds the conductive wire into the first main surface of the film, and the conductive wire to be continuously drawn out from a tip of the horn onto the first main surface of the film through an inside of the horn, and
the first end portion and the second end portion have a length for absorbing a positional deviation of the first electrode pad and the second electrode pad in the first direction relative to the circuit.

3. A method for manufacturing an embedded trace substrate, the method comprising:
preparing a film;
arranging a first electrode pad, a second electrode pad, a third electrode pad, and a fourth electrode pad at a peripheral edge of a first main surface of the film along a first direction so as to be parallel to each other and spaced from each other;
forming, on the first main surface of the film, a first circuit including a first conductive wire obtained by coating a thin metal wire with an insulating coating, the first circuit having a first functional portion having an arbitrary pattern, a first wiring portion led out from one end of both ends of the first functional portion to an outside of the first functional portion, a second wiring portion led out from another end of both ends of the first functional portion to the outside of the first functional portion, a first end portion extending in the first direction from the first wiring portion so as to partly overlap the first electrode pad, the second electrode pad, the third electrode pad, and the fourth electrode pad, and a second end portion extending along the first end portion from the second wiring portion so as to partly overlap the first electrode pad, the second electrode pad, the third electrode pad, and the fourth electrode pad, the first circuit being formed by embedding the first functional portion, the first wiring portion, the second wiring portion, and sections of the first end portion and the second end portion not overlapping the first electrode pad, the second electrode pad, the third electrode pad, and the fourth electrode pad in the first main surface of the film using an ultrasonic welding machine;
forming, on the first main surface of the film, a second circuit including a second conductive wire obtained by coating a thin metal wire with an insulating coating, the second circuit having a second functional portion having an arbitrary pattern, a third wiring portion led out from one end of both ends of the second functional portion to an outside of the second functional portion, a fourth wiring portion led out from another end of both ends of the second functional portion to the outside of the second functional portion, a third end portion extending in the first direction from the third wiring portion so as to partly overlap the first electrode pad, the second electrode pad, the third electrode pad, and the fourth electrode pad, and a fourth end portion extending along the third end portion from the fourth wiring portion so as to partly overlap the first electrode pad, the second electrode pad, the third electrode pad, and the fourth electrode pad, the second circuit being formed by embedding the second functional portion, the third wiring portion, the fourth wiring portion, and sections of the third end portion and the fourth end portion not overlapping the first electrode pad, the second electrode pad, the third electrode pad, and the fourth electrode pad in the first main surface of the film using an ultrasonic welding machine;
removing the insulating coating of the first conductive wire located on the first electrode pad and electrically connecting the thin metal wire that is exposed to the first electrode pad;
removing the insulating coating of the first conductive wire located on the second electrode pad and electrically connecting the thin metal wire that is exposed to the second electrode pad;
removing the insulating coating of the second conductive wire located on the third electrode pad and electrically connecting the thin metal wire that is exposed to the third electrode pad; and
removing the insulating coating of the second conductive wire located on the fourth electrode pad and electrically connecting the thin metal wire that is exposed to the fourth electrode pad, wherein
one end connected to the first wiring portion out of both ends of the first end portion, one end connected to the second wiring portion out of both ends of the second end portion, one end connected to the third wiring portion out of both ends of the third end portion, and one end connected to the fourth wiring portion out of both ends of the fourth end portion are located on a same side with respect to the first electrode pad, the second electrode pad, the third electrode pad, and the fourth electrode pad in plan view,
in the forming of the first circuit, the ultrasonic welding machine includes a horn that melts a contact surface of the film with the first conductive wire by applying ultrasonic vibration and that embeds the first conductive wire into the first main surface of the film, and the first conductive wire to be continuously drawn out from a tip of the horn onto the first main surface of the film through an inside of the horn,
in the forming of the second circuit, the ultrasonic welding machine includes the horn that melts a contact surface of the film with the second conductive wire by applying ultrasonic vibration and that embeds the second conductive wire into the first main surface of the film, and the second conductive wire to be continuously drawn out from the tip of the horn onto the first main surface of the film through the inside of the horn, and
the first end portion, the second end portion, the third end portion, and the fourth end portion have a length for absorbing a positional deviation of the first electrode pad, the second electrode pad, the third electrode pad, and the fourth electrode pad in the first direction relative to the first circuit and the second circuit.

4. A method for manufacturing an embedded trace substrate, the method comprising:
preparing a film;
arranging a first electrode pad, a second electrode pad, a third electrode pad, and a fourth electrode pad at a peripheral edge of a first main surface of the film along a first direction so as to be parallel to each other and spaced from each other;
forming, on the first main surface of the film, a first circuit including a first conductive wire obtained by coating a thin metal wire with an insulating coating, the first circuit having a first functional portion having an arbitrary pattern, a first wiring portion led out from one end of both ends of the first functional portion to an outside of the first functional portion, a second wiring portion led out from another end of both ends of the first functional portion to the outside of the first functional portion, a first end portion extending in the first direction from the first wiring portion so as to partly overlap the first electrode pad, the second electrode pad, the third electrode pad, and the fourth electrode pad, and a second end portion extending along the first end portion from the second wiring portion so as to partly overlap the first electrode pad, the second electrode pad, the third electrode pad, and the fourth electrode pad, the first circuit being formed by embedding the first functional portion, the first wiring portion, the second wiring portion, and sections of the first end portion and the second end portion not overlapping the first electrode pad, the second electrode pad, the third electrode pad, and the fourth electrode pad in the first main surface of the film using an ultrasonic welding machine;
forming, on the first main surface of the film, a second circuit including a second conductive wire obtained by coating a thin metal wire with an insulating coating, the second circuit having a second functional portion having an arbitrary pattern, a third wiring portion led out from one end of both ends of the second functional portion to an outside of the second functional portion, a fourth wiring portion led out from another end of both ends of the second functional portion to the outside of the second functional portion, a third end portion extending in the first direction from the third wiring portion so as to partly overlap the first electrode pad, the second electrode pad, the third electrode pad, and the fourth electrode pad, and a fourth end portion extending along the third end portion from the fourth wiring portion so as to partly overlap the first electrode pad, the second electrode pad, the third electrode pad, and the fourth electrode pad, the second circuit being formed by embedding the second functional portion, the third wiring portion, the fourth wiring portion, and sections of the third end portion and the fourth end portion not overlapping the first electrode pad, the second electrode pad, the third electrode pad, and the fourth electrode pad in the first main surface of the film using an ultrasonic welding machine;
removing the insulating coating of the first conductive wire located on the first electrode pad and electrically connecting the thin metal wire that is exposed to the first electrode pad;
removing the insulating coating of the first conductive wire located on the second electrode pad and electrically connecting the thin metal wire that is exposed to the second electrode pad,
removing the insulating coating of the second conductive wire located on the third electrode pad and electrically connecting the thin metal wire that is exposed to the third electrode pad; and
removing the insulating coating of the second conductive wire located on the fourth electrode pad and electrically connecting the thin metal wire that is exposed to the fourth electrode pad, wherein
one end connected to the first wiring portion out of both ends of the first end portion and one end connected to the second wiring portion out of both ends of the second end portion are located on a same side with respect to the first electrode pad, the second electrode pad, the third electrode pad, and the fourth electrode pad in plan view,
one end connected to the third wiring portion out of both ends of the third end portion and one end connected to the fourth wiring portion out of both ends of the fourth end portion are located on a same side with respect to the first electrode pad, the second electrode pad, the third electrode pad, and the fourth electrode pad in plan view,
the one ends of the third end portion and the fourth end portion and the one ends of the first end portion and the second end portion are located at positions sandwiching the first electrode pad, the second electrode pad, the third electrode pad, and the fourth electrode pad in plan view,
in the forming of the first circuit, the ultrasonic welding machine includes a horn that melts a contact surface of the film with the first conductive wire by applying ultrasonic vibration and that embeds the first conductive wire into the first main surface of the film, and the first conductive wire to be continuously drawn out from a tip of the horn onto the first main surface of the film through an inside of the horn,
in the forming of the second circuit, the ultrasonic welding machine includes the horn that melts a contact surface of the film with the second conductive wire by applying ultrasonic vibration and that embeds the second conductive wire into the first main surface of the film, and the second conductive wire to be continuously drawn out from the tip of the horn onto the first main surface of the film through the inside of the horn, and
the first end portion, the second end portion, the third end portion, and the fourth end portion have a length for absorbing a positional deviation of the first electrode pad, the second electrode pad, the third electrode pad, and the fourth electrode pad in the first direction relative to the first circuit and the second circuit.
